(19) United States
(12) Patent Application Publication
(10) Pub. No.: US 2003/0216139 A1
(43) Pub. Date: Nov. 20, 2003

(54) System and method for wireless control of remote electronic systems based on timing information

(75) Inventors: Thomas R. Olson, Holland, MI (US); Kim L. Van Order, Hamilton, MI (US); Thomas S. Wright, Holland, MI (US)

Correspondence Address: FOLEY & LARDNER, 777 EAST WISCONSIN AVENUE, SUITE 3800, MILWAUKEE, WI, 53202-5308, US

(73) Assignee: Johnson Controls Technology company

(21) Appl. No.: 10/147,713

(22) Filed: May 16, 2002

(51) Int. Cl. H04M 3/00

(52) U.S. Cl. 455/419; 455/418

(57) ABSTRACT

A wireless control system for wireless control of a remote electronic system includes a wireless control system circuit coupled to a vehicle interior. The circuit includes a transmitter circuit configured to transmit a wireless control signal having control data which will control the remote electronic system, a timing circuit configured to transmit a timing signal, and a control circuit coupled to the transmitter circuit and the timing circuit. The control circuit is configured to receive the timing signal and to command the transmitter circuit to transmit the wireless control signal based on the timing signal.

### BACKGROUND

In the field of wireless control of remote electronic systems, technological advances have been developed to improve convenience, security, and functionality for the user. One example is a trainable transceiver for use with various remote electronic systems, such as security gates, garage door openers, lights, and security systems. The remote electronic system may be located in a user's home, place of business, or recreational building, among others. A user trains the trainable transceiver by, for example, transmitting a signal from a remote controller in the vicinity of the trainable transceiver. The trainable transceiver learns the carrier frequency and data code of the signal and stores this code for later retransmission. In this manner, the trainable transceiver can be conveniently mounted within a vehicle interior element (e.g., visor, instrument panel, overhead console, etc.) and can be configured to operate one or more remote electronic systems.

Further advances are needed in the field of wireless control of remote electronic systems, particularly in the case of using automotive electronics to control remote electronic systems. As automotive manufacturers are adding increased electronic systems to the vehicle to improve convenience, comfort, productivity, and security simplifying the interface and control of these electronic systems is also becoming increasingly important.

Navigation systems, such as the global positioning system, vehicle compass, distance sensors, and other navigation systems, are being added to vehicles to provide navigation information to the vehicle occupants. On-board navigation systems also present opportunities to improve existing electronic systems to take advantage of vehicle location data which was not previously available.

Clocks and timing circuits, such as an in-dash clock, a trip computer clock, or a radio clock, are often currently included in vehicles. Timing information can be used to provide depth of functionality to various electronic systems in the vehicle.

One drawback of existing garage door openers is that users can inadvertently leave the garage door open at night, which can compromise the security of the home of contents of the garage. Additionally, a person may not want the garage to close upon depression of a button, it may be desirable to have a customizable delay built following depression of the button. A customizable delay allows the user to exit the garage or transfer from the car into to the home before the garage door closes.

What is needed is an improved wireless control system and method for wireless control of a remote electronic system from a vehicle or a keyfob, wherein a time of day or an elapsed time is used to improve the convenience, functionality, and security of the wireless control system. Further, what is needed is a system and method of training a wireless control system on a vehicle for wireless control of a remote electronic system based on timing information. Further still, what is needed is a transmitter for wirelessly controlling a plurality of remote electronic systems. Further yet, what is needed is a system and method for wireless control of a garage door opener based on the time of day or an elapsed time.

The teachings hereinbelow extend to those embodiments which fall within the scope of the appended claims, regardless of whether they accomplish one or more of the above-mentioned needs.

### SUMMARY

According to an exemplary embodiment, a wireless control system for wireless control of a remote electronic system includes a wireless control system circuit. The circuit includes a transmitter circuit configured to transmit a wireless control signal having control data which will control the remote electronic system, a timing circuit configured to transmit a timing signal, and a control circuit coupled to the transmitter circuit and the timing circuit configured to receive the timing signal and to command the transmitter circuit to transmit the wireless control signal based on the timing signal.

According to another exemplary embodiment, a method of training a wireless control system for wireless control of a remote electronic system based on a timing signal includes receiving a request to begin training from a user, receiving a timing target, recording the timing target, associating a wireless control signal with the timing signal, and receiving a request to end training from the user.

According to yet another exemplary embodiment, a method of wirelessly controlling a remote electronic system based upon a timing signal using a wireless control system. The method includes receiving a timing signal from a timing circuit, retrieving a stored timing value, comparing the timing signal to the stored timing value, and transmitting a wireless control signal. The wireless control signal includes control data which will control the remote electronic system when the timing signal corresponds to the stored timing value.

According to still another exemplary embodiment, a transmitter for wirelessly controlling a plurality of remote electronic systems includes a wireless circuit. The circuit includes a memory configured to store a plurality of control data messages, each control data message configured to control a different remote electronic system, a transmitter circuit configure to transmit the control data messages to a remote electronics system, a timing circuit configured to provide a timing signal, and a control circuit. The control circuit is configured to command the transmitter circuit to transmit at least one wireless signal in response to a timing signal provided by the timing circuit, each wireless signal containing a different control data message.

According to yet another exemplary embodiment, a wireless control system coupled to transmitter includes a computer coupled to a vehicle interior element, a transmitter in communication with the computer, the transmitter being configured to transmit a wireless control signal having control data which will control a remote electronic system, a timer in communication with the computer, the timer being configured to provide a timing signal, and a control program operative on the computer. The control program is configured to receive data from the timing signal and to send a command signal to the transmitter to transmit the wireless control signal based on the data from the timing signal.

### BRIEF DESCRIPTION OF THE DRAWINGS

The invention will become more fully understood from the following detailed description, taken in conjunction with the accompanying drawings, wherein like reference numerals refer to like parts, and in which:

FIG. 1 is a perspective view of a vehicle having a wireless control system, according to an exemplary embodiment;

FIG. 2 is a block diagram of a wireless control system and a remote electronic system, according to an exemplary embodiment;

FIG. 3 is a schematic diagram of a visor having a wireless control system mounted thereto, according to an exemplary embodiment;

FIG. 4 is a flowchart of a method of training the wireless control system of FIG. 2, according to an exemplary embodiment;

FIG. 5 is a chart of a set of data pairs stored in memory, each data pair including a heading and a corresponding distance, according to an exemplary embodiment;

FIG. 6 is a block diagram of a transmitter for wirelessly controlling a plurality of remote electronic systems, according to an exemplary embodiment;

FIG. 7 is a flowchart of a method of wireless control of remote electronic systems based on location, according to an exemplary embodiment;

FIG. 8 is a flowchart of the “Calculate Distance” subroutine of the method of FIG. 7, according to an exemplary embodiment;

FIG. 9 is a flowchart of a “Calculate Heading” subroutine of the method of FIG. 7, according to an exemplary embodiment;

FIG. 10 is a flowchart of a “Home Check” subroutine of the method of FIG. 7, according to an exemplary embodiment;

FIG. 11 is a flowchart of a “Vector Filter” subroutine of the method of FIG. 7, according to an exemplary embodiment;

FIG. 12 is a block diagram of a wireless control system including a timing circuit, according to an exemplary embodiment;

FIG. 13 is a front view of a wireless control system mounted in an overhead console, according to an exemplary embodiment;

FIG. 14 is a flowchart of a method of training a wireless control system including a timing circuit, according to an exemplary embodiment; and

FIG. 15 is a flowchart of a method of wireless control of remote electronic systems based on a timing signal, according to an exemplary embodiment.

### DETAILED DESCRIPTION OF EXEMPLARY EMBODIMENTS

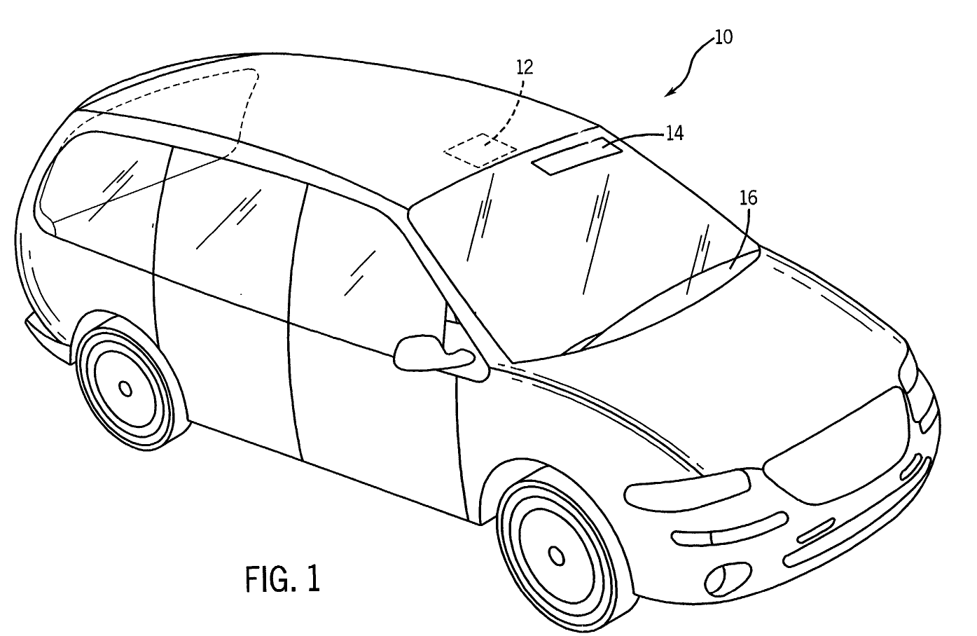

Referring first to FIG. 1, a vehicle 10, which may be an automobile, truck, sport utility vehicle (SUV), mini-van, or other vehicle, includes a wireless control system 12. Wireless control system 12, the exemplary embodiments of which will be described hereinbelow, is illustrated mounted to an overhead console of vehicle 10. Alternatively, one or more of the elements of wireless control system 12 may be mounted to other vehicle interior elements, such as, a visor 14, an overhead console, or instrument panel 16. Alternatively, wireless control system 12 could be mounted to a key chain, keyfob or other handheld device.

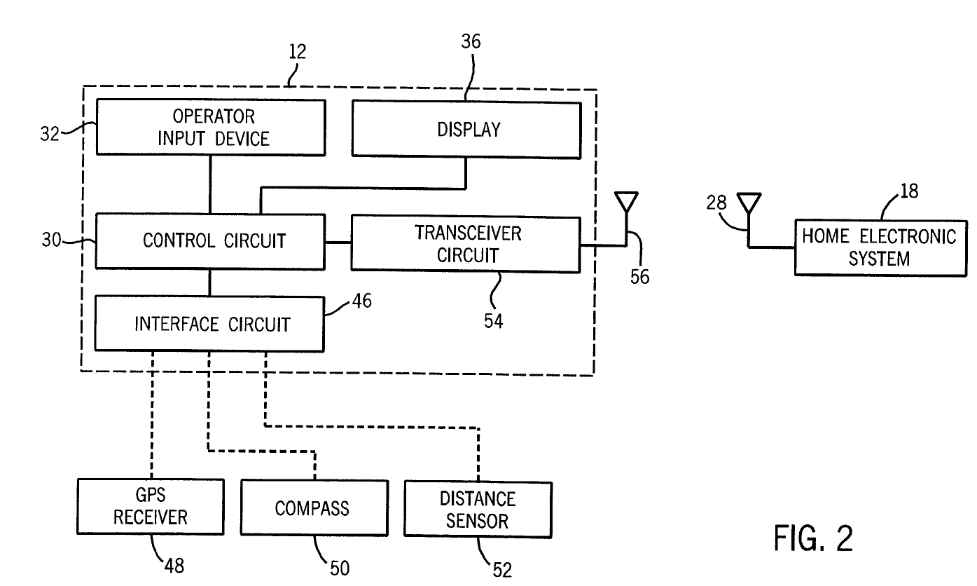

Referring now to FIG. 2, wireless control system 12 is illustrated along with a remote electronic system 18 which may be any of a plurality of remote electronic systems, such as, a garage door opener, a security gate control system, security lights, home lighting fixtures or appliances, a home security system, etc. For example, remote electronic system 18 may be a garage door opener, such as the Whisper Drive® garage door opener, manufactured by the Chamberlain Group, Inc., Elmhurst, Ill. Home electronic system 18 may also be a lighting control system using the X10 communication standard. Home electronic system 18 includes an antenna 28 for receiving wireless signals including control data which will control remote electronic system 18. The wireless signals are preferably in the ultra-high frequency (UHF) band of the radio frequency spectrum, but may alternatively be infrared signals or other wireless signals.

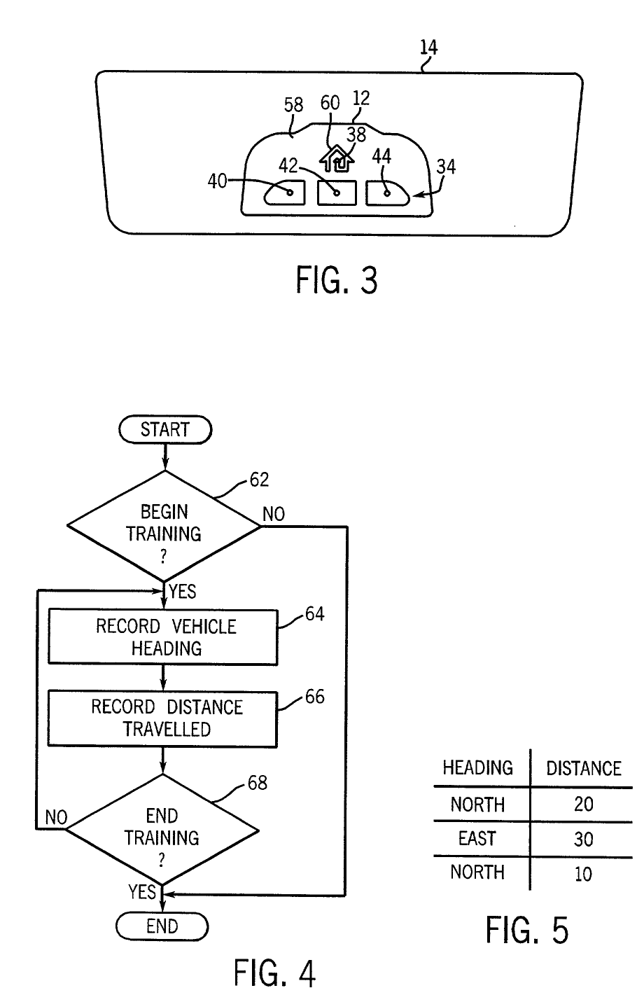

Wireless control system 12 includes a control circuit 30 configured to control the various portions of system 12, to store data in memory, to operate preprogrammed functionality, etc. Control circuit 30 may include various types of control circuitry, digital and/or analog, and may include a microprocessor, microcontroller, application-specific integrated circuit (ASIC), or other circuitry configured to perform various input/output, control, analysis, and other functions to be described herein. Control circuit 30 is coupled to an operator input device 32 which includes one or more push button switches 34 (see FIG. 3), but may alternatively include other user input devices, such as, switches, knobs, dials, etc., or more advanced input devices, such as biometric devices including fingerprint or eye scan devices or even a voice-actuated input control circuit configured to receive voice signals from a vehicle occupant and to provide such signals to control circuit 30 for control of system 12.

Control circuit 30 is further coupled to a display 36 which includes a light-emitting diode (LED), such as, display element 38. Display 36 may alternatively include other display elements, such as a liquid crystal display (LCD), a vacuum florescent display (VFD), or other display elements.

Wireless control system 12 further includes an interface circuit configured to receive navigation data from one or more navigation data sources, such as a GPS receiver 48, a vehicle compass 50, a distance sensor 52, and/or other sources of navigation data, such as gyroscopes, etc. Interface circuit 46 is an electrical connector in this exemplary embodiment having pins or other conductors for receiving power and ground, and one or more navigation data signals from a vehicle power source and one or more navigation data sources, respectively, and for providing these electrical signals to control circuit 30. GPS receiver 48 is configured to receive positioning signals from GPS satellites, to generate location signals (e.g., latitude/longitude/altitude) representative of the location of wireless control system 12, and to provide these location signals to control circuit 30 via interface circuit 46. Compass 50 includes compass sensors and processing circuitry configured to receive signals from the sensors representative of the Earth's magnetic field and to provide a vehicle heading to control circuit 30. Compass 50 may use any magnetic sensing technology, such as magneto-resistive, magneto-inductive, or flux gate sensors. The vehicle heading may be provided as an octant heading (N, NE, E, SE, etc.) or in degrees relative to North, or in some other format. Distance sensor 52 may include an encoder-type sensor to measure velocity and/or position or may be another distance sensor type. In this embodiment, distance sensor 52 is a magnetic sensor coupled to the transmission and configured to detect the velocity of the vehicle. A vehicle bus interface receives the detected signals and calculates the distance traveled based on a clock pulse on the vehicle bus. Other distance and/or velocity sensor types are contemplated, such as, using GPS positioning data.

Wireless control system 12 further includes a transceiver circuit 54 including transmit and/or receive circuitry configured to communicate via antenna 56 with remote electronic system 18. Transceiver circuit 54 is configured to transmit wireless control signals having control data which will control remote electronic system 18. Transceiver circuit 54 is configured, under control from control circuit 30, to generate a carrier frequency at any of a number of frequencies in the ultra-high frequency range, preferably between 260 and 470 megaHertz (MHz), wherein the control data modulated on to the carrier frequency signal may be frequency shift key (FSK) or amplitude shift key (ASK) modulated, or may use another modulation technique. The control data on the wireless control signal may be a fixed code or a rolling code or other cryptographically encoded control code suitable for use with remote electronic system 18.

Referring now to FIG. 3, an exemplary wireless control system 10 is illustrated coupled to a vehicle interior element, namely a visor 14. Visor 14 is of conventional construction, employing a substantially flat, durable interior surrounded by a cushioned or leather exterior. Wireless control system 12 is mounted to visor 14 by fasteners, such as, snap fasteners, barbs, screws, bosses, etc. and includes a molded plastic body 58 having three push button switches disposed therein. Each of the switches includes a respective back-lit icon 40, 42, 44. Body 58 further includes a logo 60 inscribed in or printed on body 58 and having a display element 30 disposed therewith. During training and during operation, display element 38 is selectively lit by control circuit 30 (FIG. 2) to communicate certain information to the user, such as, whether a training process was successful, whether the control system 12 is transmitting a wireless control signal, etc. The embodiment shown in FIG. 3 is merely exemplary, and alternative embodiments may take a variety of shapes and sizes, and have a variety of different elements.

In operation, wireless control system 12 is configured for wireless control of remote electronic system 18 based on the location of wireless control system 12. Control circuit 30 is configured to receive navigation data from a navigation data source to determine a proximity between system 12 and system 18, and to command transceiver circuit 54 to transmit a wireless control signal based on the proximity between system 12 and system 18.

Several training steps can be performed by the user. Home electronic system 18 is placed in an “auto open” mode. System 12 is also placed in an “auto open” mode. Both such mode selections can be selected using operator input devices. System 12 is trained to learn the location of remote electronic system 18, which may be defined as the location of one or more of a garage door, a security gate, a home lighting or appliance element, a home security system, the location of the home associated with remote electronic system 18, the location of antenna 28, or any other location associated with remote electronic system 18. In this exemplary embodiment, system 12 learns the location of remote electronic system 18 in one of two ways. In a first method, in which data from GPS receiver 48 is available, the user actuates one of switches 34 to change the mode of wireless control system 12 to a training mode. With system 12, and more particularly the antenna of GPS receiver 48, positioned at the location of remote electronic system 18, the user actuates one of the switches 34 to command control circuit 30 to take a location reading from GPS receiver 48 and to store this location information in memory, preferably in non-volatile memory, in order to train system 12 to learn the location of remote electronic system 18. Alternatively, in a system wherein GPS signals are not available, system 12 uses information from compass 50 and distance sensor 52 to train system 12 to learn the location of remote electronic system 18, as will now be described with reference to FIG. 4.

Referring to FIG. 4, an exemplary method of training a wireless control system on a vehicle for wireless control of a remote electronic system will now be described. At step 62, control circuit 30 identifies whether the user has requested system 12 to enter a training mode to begin training. For example, the user may hold down one, two, or more of switches 34 for a predetermined time period (e.g., 10 seconds, 20 seconds, etc.) to place control circuit 30 in a training mode, or the user may actuate a separate input device (not shown in FIG. 3) coupled to control circuit 30 (FIG. 2) to place system 12 in the training mode. Once training has begun, at step 64, control circuit 30 receives heading signals from compass 50 via interface circuit 46. Control circuit 30 records the vehicle heading in memory, wherein the vehicle heading is received from a GPS receiver or a compass. At step 66, control circuit 30 further receives distance signals representing the distance traveled by the vehicle from distance sensor 52 via interface circuit 46. The distance traveled is recorded in memory. Typically, the heading signals and distance traveled are recorded over one or more turns of vehicle 10 to provide a unique path which can be identified as a path associated with the vehicle approaching remote electronic system 18. Heading data and distance data are recorded as the vehicle makes at least one change in heading. Heading data and distance data are recorded in a set of data pairs representing a path beginning some distance from system 18 (e.g., one block, multiple blocks, one mile, several miles, etc.) and ending in the vicinity (e.g., less than a few hundred feet) of system 18.

Typically a vehicle operator will use between one and three routes to approach their home. The method described in FIG. 4 can be repeated for multiple routes. The operator may program some routes for which they wish to cause automatic transmission of wireless data, as will be described below, and may further choose not to program system 12 for other routes for which they do not want to cause automatic transmission of wireless signals. Preferably, training begins at a location that is far enough from the home that a unique route can be established, yet close enough to the home so that the route home is consistent over several trips home. The vehicle operator can decide whether to include the final turn into the driveway to make the route unique. If the final turn into the driveway is included, the automatic transmit function, as will be described hereinafter, will be delayed until after the car has completed its turn into the driveway.

When the user travels in the vehicle to the end of the training path (i.e., in the vicinity of system 18), the user stops the vehicle and presses one of switches 34 corresponding to the end of training, as indicated at step 68. Between the start and end of the training path, control circuit 30 records in memory the distance traveled on each heading during the drive to the home. Control circuit 30 will then record and save in memory one or more tables such as that shown in FIG. 5. FIG. 5 illustrates a set of predetermined heading and distance data represented as a plurality of data pairs, each data pair including a heading and a corresponding distance. For example, in the exemplary data pair shown, the heading of north is taken for a distance of 20 units (each unit representing a 20 foot increment in this exemplary embodiment, though alternative measures may be implemented), a heading of east for 30 units, and a heading of north for 10 units.

Having trained system 12 to identify the location of remote electronic system 18 using either GPS positioning signals or by identifying one or more paths to remote electronic system 18, or by otherwise training system 12 to learn the proximity or distance between system 12 and system 18, system 12 may then be used in its operative mode to automatically transmit wireless control data based on the proximity between system 12 and system 18. For example, when GPS positioning signals are used, during normal vehicle driving, control circuit 30 continuously monitors the location of the vehicle and, when the vehicle is within a predetermined distance (e.g., 5 miles, 1 mile, 2 blocks, etc.), control circuit 30 commands transceiver circuit 54 to transmit a wireless control signal having control data to control one or more of remote electronic systems 18. In this exemplary embodiment, the wireless control signal is transmitted automatically (i.e., without requiring the user to press a button) in two five-second bursts with a three second delay between bursts. Alternatively, the wireless control signal can be transmitted with greater or fewer numbers of bursts and with different durations and delay times.

In the case where vehicle compass and distance sensor data are utilized, control circuit 30 will continuously monitor heading and distance information via interface circuit 46 and will compare the heading and distance information to the sets of data pairs in memory representing one or more paths indicating when a vehicle returns to the home. When a match is identified, control circuit 30 will command transceiver 54 to transmit the wireless control signal. Preferably, a tolerance of +/−20% (or some other percentage) is provided for the distances during the comparison steps.

According to one exemplary embodiment, when wireless control system 12 is within a first proximity of remote electronic system 18, wireless control data is automatically transmitted in a plurality of bursts. Thereafter, wireless control system 12 monitors the proximity of system 12 to system 18 until the proximity is at a second proximity which is greater than the first proximity. After system 12 is outside the second proximity, system 12 is “reset,” such that when systems 12 and 18 are again within the first proximity, system 12 again automatically transmits the wireless control signal. Alternatively, the first and second proximities can be the same or the second proximity can be less than the first. In either event, system 12 advantageously prevents multiple retransmissions while system 12 is within the first proximity, but not having just returned home.

According to another exemplary embodiment, wireless control system 12 can be trained to automatically learn the pathway to remote electronic system 18. In this embodiment, system 12 continuously monitors travel vectors (i.e., distance and heading) and stores the vectors in a buffer. When system 12 detects a manual actuation of one of input devices 34 to send wireless control signals, system 12 concludes it is at or near system 18. Therefore, system 12 records a predetermined number of previous travel vectors (e.g., three, five, ten, etc.) in memory. The next time system 12 travels the same recorded travel vector pattern, system 12 automatically transmits wireless control data to actuate system 18. System 12 determines whether the same recorded travel vector pattern is traveled by waiting until a first vector of a pattern is found, then comparing the vector of the next turn to the next vector in the pattern, and so on, until all vectors in the pattern have been matched. Pattern matching and position matching (as with GPS distance data) can be used together to verify that the system works effectively. Preferably, system 12 requires the user to select this automatic training feature using one or more of input devices 34 before automatic training will take place. Multiple paths home can be recorded in this manner. Preferably the travel path includes the turn into the driveway of the home so that automatic transmission of wireless control data can be prevented by stopping the vehicle on the street in front of the house.

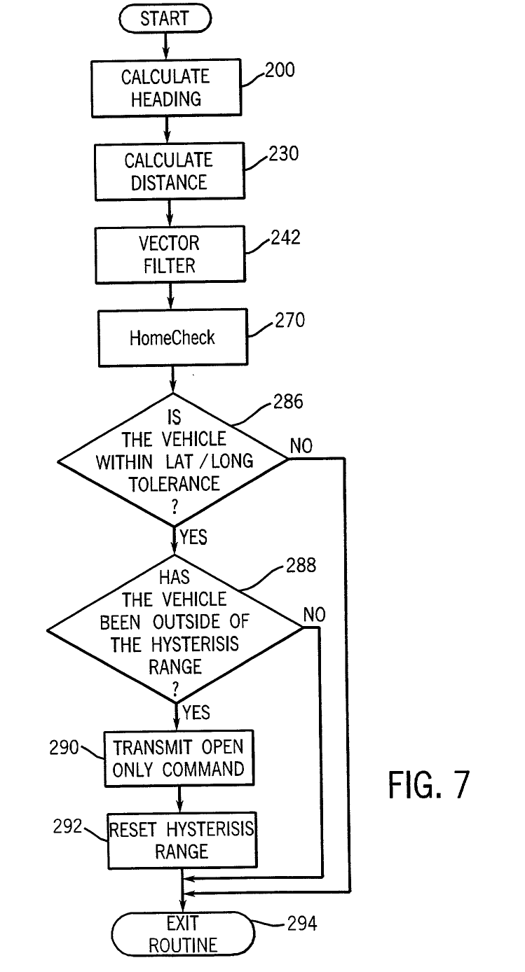

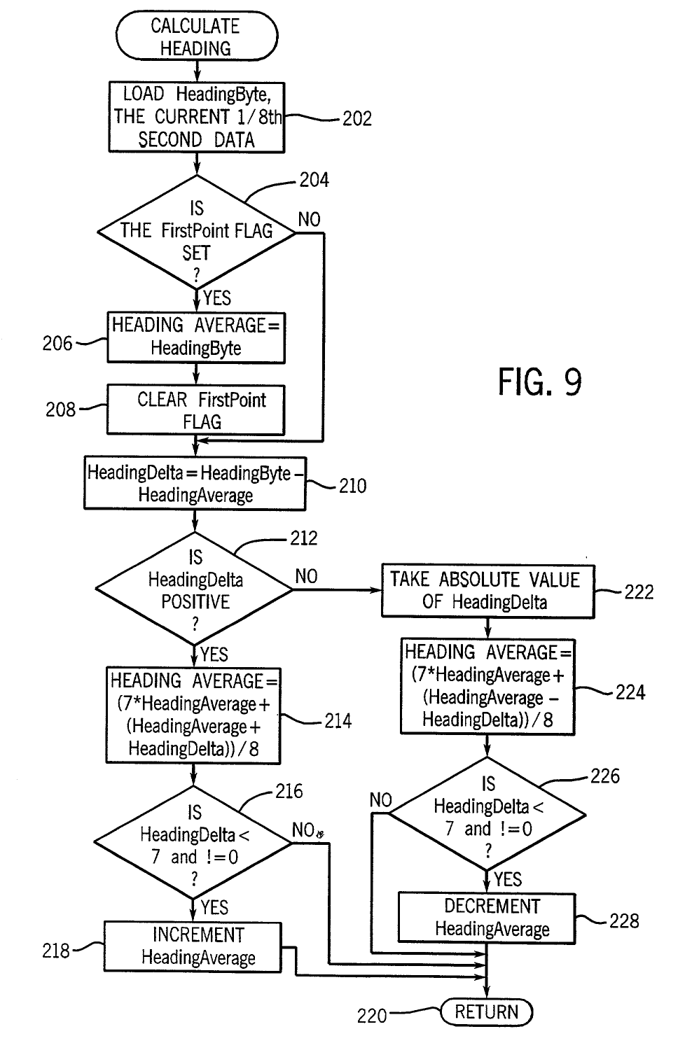

Referring now to FIGS. 7-11, a method of wireless control of a remote electronic system based on location will be described, according to another exemplary embodiment. The method can be operable in software and/or hardware on system 12 in any of its various embodiments. At step 200, the “Calculate Heading” subroutine is called. Referring to FIG. 9, at step 202, every ⅛^{th} second, the current heading of the vehicle is detected. At step 204, if the heading byte loaded is the first point of a heading vector, a heading average is set equal to the heading byte at step 206, a FirstPoint flag is set at step 208, and the method proceeds to step 210. At step 204, if the loaded heading is not the first point of a heading vector, the method proceeds to step 210.

At step 210, the change in heading is calculated by subtracting the average heading from the recently loaded heading. At step 212, if the heading change is positive, a new heading average is calculated at step 214 according to the following equation:

Heading Average=(7*HeadingAverage+(HeadingAverage+HeadingDelta))/8

At step 216, if the change in heading is less than 7 and not equal to 0, the heading average is incremented at step 218 and the subroutine returns at step 220. If the change in heading is greater than 7 or equal to 0, the heading average is not incremented, and the subroutine returns at step 220.

At step 212, if the heading change is not positive, the absolute value of the heading data is taken at step 222, and the heading average is calculated at step 224 using the same equation as step 214. After step 224, at step 226, if the heading delta is less than 7 and not equal to 0, the heading average is decremented at step 228, and the subroutine ends at step 220. At step 226, if the change in heading is greater than 7 or equal to 0, the method proceeds to step 220 to return to the main routine.

Referring again to FIG. 7, upon return of the “Calculate Heading” subroutine, the main routine calls the “Calculate Distance” subroutine at step 230. Referring to FIG. 8, at step 232, if the distance is the first distance point of a new vector, the distance accumulator is cleared at step 234, and a flag is set at step 236 to indicate that the distance of a new vector is being calculated. The method then proceeds to step 238. If the distance calculation is not at the beginning of a new vector at step 232, the method proceeds to step 238. At step 238, the distance is calculated as the sum of the previous distance accumulator (which is 0 in the case of a new vector) and the latest change in distance. At step 240, the subroutine returns to the main routine.

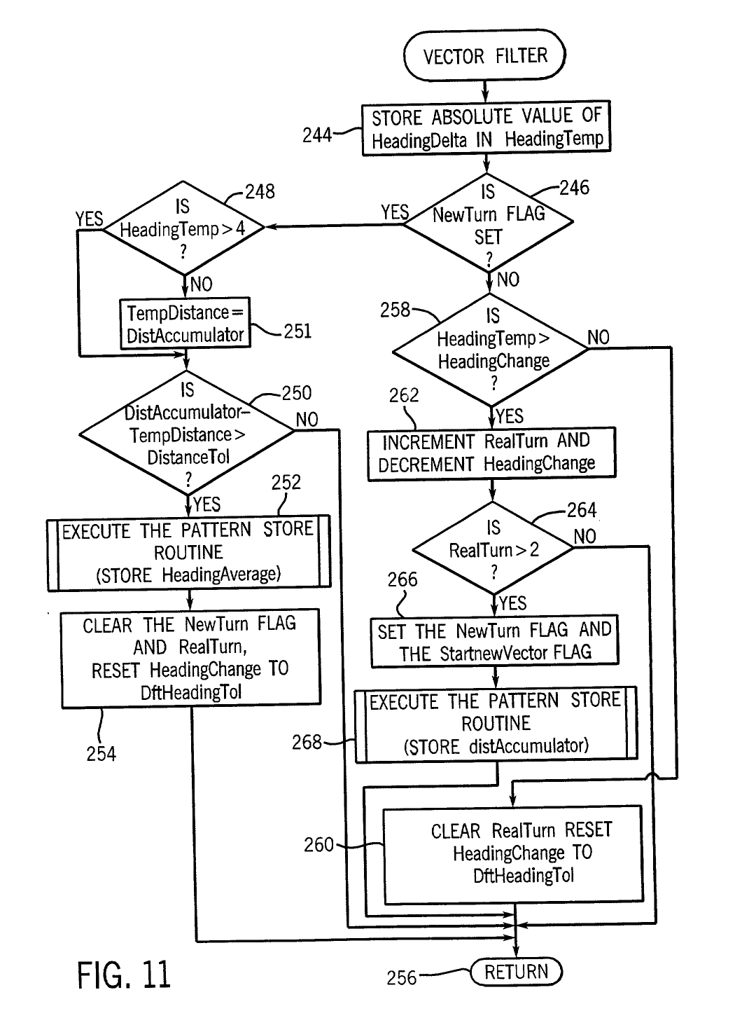

Referring again to FIG. 7, after the “Calculate Distance” subroutine at step 230, the main routine calls the “Vector Filter” subroutine at step 242. Referring to FIG. 11, at step 244, the absolute value of the change in heading is stored. If a new turn is detected at step 246, if the change in heading is greater than four units at step 248, the method proceeds to step 250. If the change in heading is not greater than four units, then the distance accumulator is saved as a temporary distance at step 251. At step 250, if the distance accumulator minus the temporary distance is greater than a predetermined distance tolerance, a pattern is stored at a pattern store routine 252 and the heading average is stored, the new turn flag and real turn flags are cleared, and the heading change is reset to a default heading tolerance at step 254. The method then returns at step 256 to the main routine.

Returning to step 246, if a new turn is not detected, the method proceeds to step 258 to determine if the recent change in heading is greater than a predetermined heading change. If not, a real turn flag is cleared and a heading change is reset to a default heading tolerance at step 260, and the method returns at step 256.

If the recent change in heading is greater than the predetermined heading change at step 258, a real turn accumulator is incremented and a heading change accumulator is decremented at step 262. At step 264, if the real turn accumulator is greater than two, a new turn flag is set and a start new vector flag is set at step 266. Subsequently, at step 268, the driving pattern of the vehicle is stored and the distance accumulator is stored, and the method returns to the main routine at step 256.

At step 264, if the real turn accumulator is not greater than two, the method returns to the main subroutine at step 256.

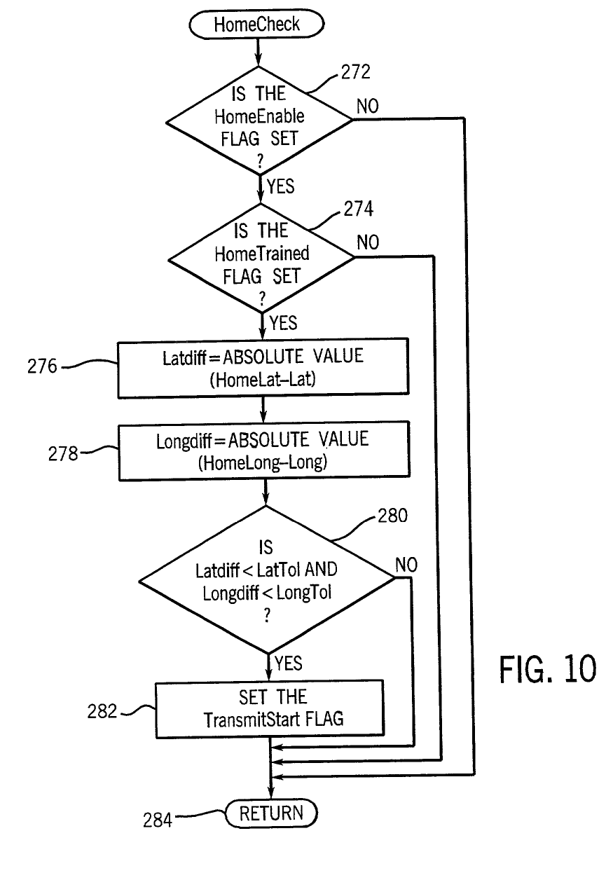

Referring again to FIG. 7, after the “Vector Filter” subroutine is executed in step 242, a “Home Check” subroutine is executed at step 270. Referring to FIG. 10, at step 272, if the system is configured for automatic transmission, the method proceeds to step 274 to see if the proximity of the system to the remote electronic system has been programmed. If so, the method proceeds to calculate the distance in latitude (step 276) and longitude (step 270) between the wireless control system and the remote electronic system. At step 280, if the systems are within a predetermined proximity, the “Transmit Start” flag is set at step 282 and the subroutine returns at step 284.

Referring to FIG. 7, if the vehicle is within the predetermined proximity of the home in step 286, the method proceeds to step 288 to determine whether the vehicle has been outside of a hysteresis range. If so, the “Open Only” command is transmitted at step 290 and the hysteresis range is reset at step 292. At step 294, the main routine is exited.

As can be seen, in the “Calculate Heading” subroutine of FIG. 9, the heading data is averaged using a weighted, running average. The current heading is compared to the heading average, and if the car has been traveling straight for some distance, there will be little difference between them. If, however, the car is in the process of turning, there will be a significant difference, and if the difference is past a predetermined threshold, then a new turn is considered to be taking place. Once the current heading matched the “Heading Average”, then the Heading Average is stored as the heading for the new vector, and the distance accumulator is reset to 0. The distance accumulator continues to increment from this point until a new turn has taken place. As soon as this new turn is detected, the value of the distance accumulator is stored as the distance value for the vector. Because this is how the vectors are stored, the heading data gets stored before the distance data. After each vector is stored, it can be compared to the pattern to see if it is one of the vectors leading to the residence. In other set of routines would control the comparison process.

Functions

void VectorFilter(void);

// This routine filters the heading and distance information and
determines when to store each into the vector

void Calculate_Heading(void);

// Handles the heading average and controls how the current
heading is added or subtracted from the average

void Calculate_Distance(void);

// Handles the Distance accumulator. Speed data is added every time
data is taken when a new vector is started. This gets stored as
the distance

void Transmit(void);

| | |
|---|---|
| // Controls the 5 second Homelink | (Not Flowcharted) |
| Transmission | |

| | |
|---|---|
| void ButtonCheck(void); | (Not Flowcharted) |

// Polls the button and checks for a press

void HomeCheck(void);

// Checks to see if the we are at home yet

Variables

| U16 Newturn :1; | | // This flag is set when a valid turn is detected and is | |
|---|---|---|---|
| | | cleared when the turn has stabilized | |
| | U16 StartnewVector :1; | | // Set when a valid turn is detected and the |
| | | | distanceAccumulator is cleared out. If this flag is set, |
| | | | it is then cleared |
| | U16 FirstPoint | :1; | // If this flag is set then its the first angle |

| | that is stored, and the current data gets stored as the | |
|---|---|---|
| | HeadingAverage | |
| U08 Heading | ; | //The Heading data for the current Vector |
| U16 Distance | ; | //The Distance data for the current Vector |

| | |
|---|---|
| U08 DistanceTol; | //The Distance value used to ensure a valid turn has |
| | been completed |
| U08 DftHeadingTol; | // The initial heading tolerance used before filtering |

U08 DftHeadingChange;

| | |
|---|---|
| U08 HeadingChange; | //The Angle value used to determine that a turn |
| | has taken place |
| U08 HeadingByte =0; | // Current 1/8th second Heading data |
| U08 HeadingAverage =0; | // Current running average of the heading |
| U08 HeadingDelta =0; | //The difference taken by subtracting the |
| | HeadingAverage from the HeadingByte |
| U32 DistAccumulator; | //Contains the summation of the speed every ⅛th |
| | second for the current vector |
| U16 DistanceVar; | // Current ⅛th second speed |

| | |
|---|---|
| U08 RealTurn; | // Checks to see if an actual turn has occurred. Is incremented |
| | upon consecutive samples of the HeadingByte that are |
| | significantly different from the HeadingAverage. |
| int PatternNum =0; | // Controls which Pattern is currently being used |
| int VectorNum =0; | // Controls which Vector is currently being used |
| U16 TempDistance; | //This contains the distance driven, after making a valid turn, |
| | before the data is stable. This is compared to a constant, and |
| | when it is greater than the constant, the Heading information |
| | will be stored for that vector and a new vector will begin |

| | |
|---|---|
| int TransmitCount = 0; | // Flags to control wireless control system to ensure that |
| | it only transmits for 5 seconds |
| int TransmitStart = 0; | |
| float Lat; | //⅛th second Latitude data |
| float Long; | //⅛th second Longitude data |
| float HomeLat =0; | // Latitude in the driveway of the residence where the |
| | system will be used |
| float HomeLong =0; | // Longitude in the driveway of the residence where the |
| | system will be used |

| | |
|---|---|
| int HomeTrained = 0; | // Flag indicating whether the system has been trained to |
| | a specific Lat/Long yet |
| int HomeEnable = 0; | // Once this flag is set, then the product is free to transmit when |
| | its within tolerance of the Home Lat/Long |
| float LatTol; | // The tolerance that controls how far away from the Home |
| | Lat/Long the system will transmit |
| float LongTol; | // The tolerance that controls how far away from the Home |
| | Lat/Long the system will transmit |
| double Latdiff; | // Contains the absolute value of the difference between the |
| | Home Lat and the current Lat |
| double Longdiff; | // Contains the absolute value of the difference between the |
| | Home Long and the current Long |

According to one exemplary embodiment, system 12 is configured for automatic transmission of wireless control signals as described in any one of the exemplary embodiments hereinabove, and is further configured to command transceiver circuit 54 to transmit the wireless control signal in response to actuation of one of switches 34. Thus, the vehicle driver has the option of relying on location-based, automatic transmission and/or manual transmission of wireless control signals.

Wireless control system 12 may be preprogrammed (e.g., during manufacture, at the dealership, etc.) with sufficient control data to operate one or more of remote electronic systems 18, or system 12 may employ a learning operation, wherein system 12 is trainable by learning the carrier frequency, data code, and/or modulation scheme on a received wireless signal. In this embodiment, transceiver 54 is configured to receive a wireless signal, for example from a hand-held remote transmitter suitable for use with one or more remote electronic systems 18. Control circuit 30 is configured to identify a data code on the received wireless signal and to store the data code in memory, wherein the wireless control signal to be transmitted by system 12 in response to automatic or manual transmission includes the stored data code. An exemplary trainable transceiver is described in U.S. Pat. No. 5,699,054, the disclosure of which is incorporated herein by reference.

A further feature which may be implemented in any of the exemplary embodiments herein is a feature of sending two or more wireless control signals simultaneously or in sequence, each wireless control signal having control data for a different remote electronic system 18. For example, as a vehicle driver approaches the home, the driver may wish to open a security gate, open a garage door, turn on lights in the home, and disable home security system, and the driver may wish to perform all these functions within a short period of time or in response to a single actuation of one of switches 34. According to one embodiment, the method of FIG. 4 includes a step wherein system 12 receives an indication from the user as to which of a plurality of wireless control signals are to be transmitted based on a single event (e.g., the location of the vehicle or based on actuation of one of switches 34). Thus, the user can select one or more wireless control signals which will automatically transmit when the vehicle is within a predetermined distance of the home (as determined by GPS signals or the predetermined heading/distance patterns).

Preferably, system 12 is configured to allow the user to select one or more wireless control signals to be transmitted automatically when the vehicle is in the vicinity of the house and one or more wireless control signals which are to be transmitted manually, i.e., in response to actuation of one or more of switches 34, each of the wireless control signals having different control data which will control a different remote electronic system 18. In one exemplary configuration, the user may wish to control a set of security lights and the garage door automatically, but the security date to open manually. In another configuration, the user may want the security light to be automatically turned on and the garage door to be manually operated. The training as to which of the wireless control signals are to be manually transmitted and which are to be automatically transmitted may be provided after step 62 in the method of FIG. 4, before step 68, or during a separate training operation.

According to one exemplary embodiment, the different wireless control signals will be transmitted in the order in which they were selected during training.

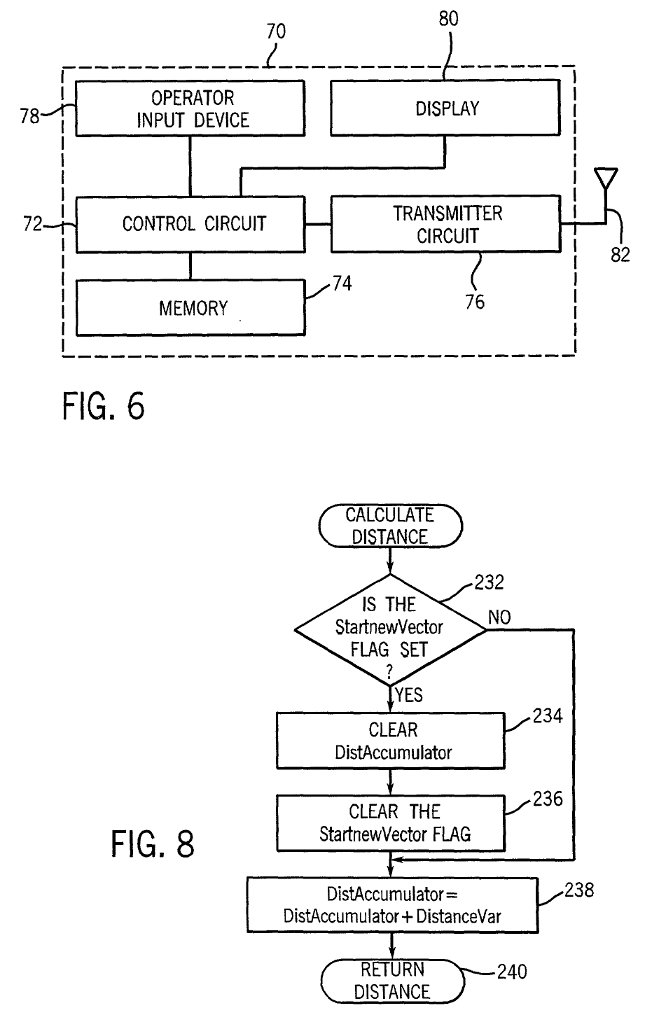

Referring now to FIG. 6, a transmitter or transceiver 70 for wirelessly controlling a plurality of remote electronic systems is illustrated, wherein the transmitter is configured to transmit a plurality of wireless control signals in response to a single event. Transmitter 70 includes a control circuit 72 similar to control circuit 30. Transmitter 70 further includes a memory 74, which may be a volatile or non-volatile memory, and may include read only memory (ROM), random access memory (RAM), flash memory, or other memory types. Transmitter 70 further includes a transmitter circuit 76 which may alternatively include receive circuitry, wherein transmitter circuit 76 is configured to transmit wireless control signals to one or more of remote electronic systems 18 (FIG. 2). Transmitter 70 may be a hand-held transmitter, or may be mounted to a vehicle interior element. Transmitter 70 includes a memory 74 configured to store a plurality of control data, each control data configured to control a different remote electronic system. Transmitter 70 may further include an operator input device 78 and a display 80, which may have a similar configuration to operator input device 32 and display 36 in the embodiment of FIG. 2. The following feature of transmitting multiple wireless signals may be provided in the simplified transmitter of FIG. 6 or may alternatively be provided in system 12 in any of its various embodiments.

In operation, control circuit 72 is configured to command transmitter circuit 76 to transmit a plurality of wireless control signals over antenna 82 in response to a single event. Each wireless control signal contains a different control data message, each control data message being retrieved from memory 74. The wireless control signals may be radio frequency, infrared, or other wireless signals. The single event may be the operator actuation of operator input device 78 by a vehicle occupant. Alternatively, or in addition, control circuit 72 may be configured to receive navigation data and to determine a distance between the transmitter and the remote electronic system 18, in which case the single event can be the control circuit 72 determining that the transmitter 70 is within a predetermined distance of remote electronic system 18.

Control circuit 72 is user-programmable such that the switch in operator input device 78 causes transmitter circuit 76 to send a first wireless control signal (e.g., to turn on security lights, open a security gate, etc.) and the control circuit 72 automatically sends a second wireless control signal different than the first wireless control signal (e.g., to lift a garage door) when control circuit 72 determines that transmitter 70 is within a predetermined distance of remote electronic system 18. Further still, one switch within operator input device 78 may cause transmitter circuit 76 to send a first wireless control signal and a second switch within operator input 78 may cause transmitter 76 to send multiple control signals, wherein the multiple wireless control signals are transmitted simultaneously or in sequence.

In an exemplary embodiment wherein system 12 or transmitter 70 sends a plurality of different wireless control signals in response to actuation of one switch, one of the wireless control signals can be transmitted for a first predetermined time period (e.g., 1 to 2 seconds), then the second wireless control signals can be transmitted for a predetermined time period, (e.g., 1 to 2 seconds) and the cycle of transmissions can be repeated until the switch is released.

The features of the exemplary embodiments herein are particularly useful with garage door opener systems which can be programmed in an “up only” mode, wherein the garage door will open when a wireless control signal is received, but if the garage door is already open, the garage door will not close, but will remain open. A second mode is that in which receipt of a wireless control signal will cause a garage door opener to close if open and open if closed, and stop if in the process of closing or opening. Thus, system 12 or transmitter 70 can be configured to transmit a unique message which will place the garage door opener into the first mode, without requiring the user to manually switch the mode of the garage door opener from the second mode to the first mode.

Utilizing the feature of an “up only” mode, in an alternative embodiment of system 12, transceiver circuit 54 is configured to transmit a wireless control signal having control data which will control a garage door opener to open if the garage door is closed and to remain open if the garage door is already open when the wireless control signal is received. During training in this or any other embodiments, the location of system 12 can be recorded from GPS satellites 48 during the training operation. Thus, control circuit 30 is configured to record the location of the wireless control system 12 in response to actuation of operator input device 32.

In some situations, a garage door opener will not be configurable for “up only” operation. In these situations, an auxiliary wireless transmitter can be used. The auxiliary wireless transmitter is disposed in the vicinity of the garage door opener (e.g., coupled to the garage wall, ceiling, or a mounting bracket) and includes a housing, a receiver, a control circuit, a garage door state sensor, and an interface circuit. The garage door state sensor is configured to detect whether the garage door is open or closed. For example, a mercury switch is coupled to the garage door which changes state based on whether the switch (or door) is vertical (garage door open) or horizontal (garage door closed). The switch includes an interface circuit configured to transmit the switch state over a wired or wireless connection to the auxiliary wireless transmitter. The auxiliary wireless transmitter is configured to receive the switch state and wireless control data from system 12 indicating an “up only” command. If the garage door is closed, the auxiliary wireless transmitter will send an “open door” command via an interface circuit having a wired or wireless communication link to the garage door opener to open the garage door. The receiver, control circuit, and interface circuit are all coupled to and preferably at least partially recessed in the housing. The interface circuit is configured to provide the “open door” command from within the housing to the existing garage door opener outside the housing. If the garage door is already open, the auxiliary wireless transmitter will not send a command to the garage door opener. In this embodiment, the auxiliary wireless transmitter and garage door state sensor act as a kit which provides “up-only” functionality to an existing garage door opener.

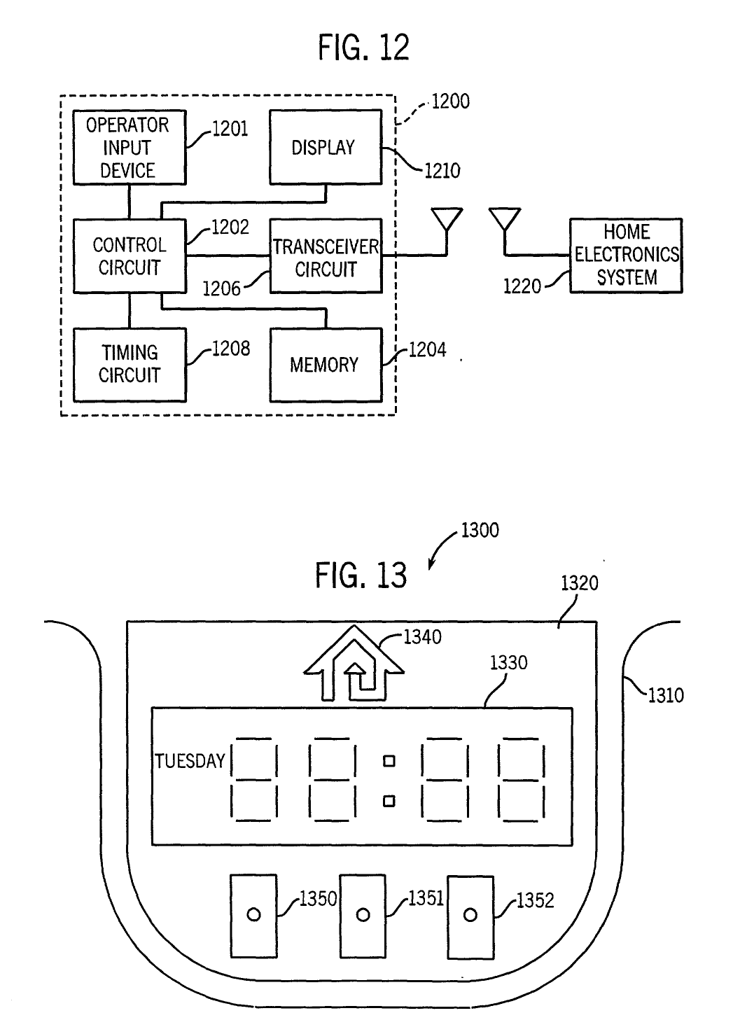

Referring now to FIG. 12, a transmitter or transceiver 1200 for wirelessly controlling a remote electronics system in response to timing information is illustrated, wherein the transmitter is configured to transmit a wireless control signal when a timing signal corresponds to a stored timing value. Transmitter 1200 can include an operator input device 1201, similar to operator input device 32, a control circuit 1202, similar to control circuit 30 (FIG. 2), a memory 1204, similar to memory 74 (FIG. 6), and a transceiver circuit 1206, similar to transceiver circuit 54 (FIG. 2), wherein transceiver circuit 1206 is configured to transmit wireless control signals to one or more of remote electronics system 1220. Transmitter 1200 can further include a timing circuit 1208 and a visual display 1210. Transmitter 1200 may be mounted to or enclosed in a vehicle interior element. Visual display 1210 can be an LCD screen, a cathode ray tube, a touch screen, an LED clock face, or any other type of visual display for displaying information to an operator.

Timing circuit 1208 is configured to provide a timing signal representing a clock time or time of day. Timing circuit 1208 may be a radio receiver chip connected to an antenna. According to an exemplary embodiment, the radio receiver chip can receive current atomic clock time information carried on an FM radio wave signal from a remote source. Control circuit 1202 can be configured to examine the signal to provide a current time. According to an alternative embodiment, timing circuit 1208 can include a crystal clock chip. The crystal clock chip can be used to provide a current time signal following initialization of the crystal clock chip. According to another alternative embodiment, timing circuit 1208 may be external to transmitter 1200 in communication with transmitter 1200 over a vehicle communication bus. An external timing circuit 1208 can be a clock associated with a radio, a clock associated with a trip computer, or a clock mounted in a dashboard.

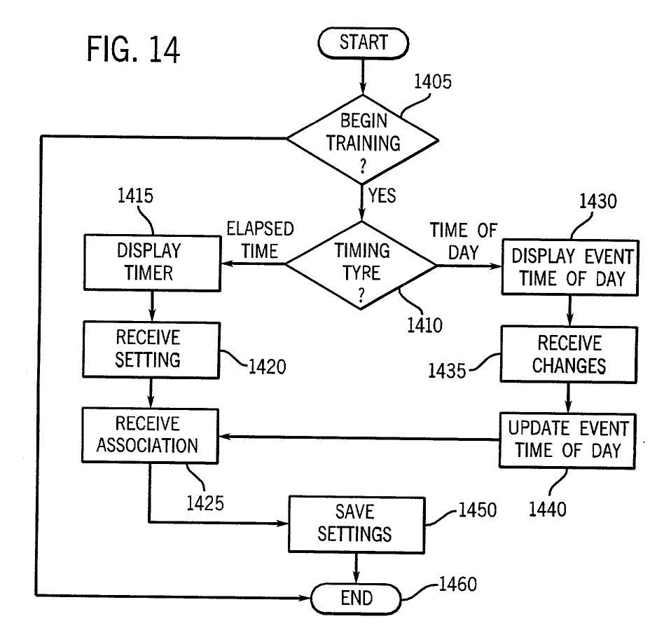

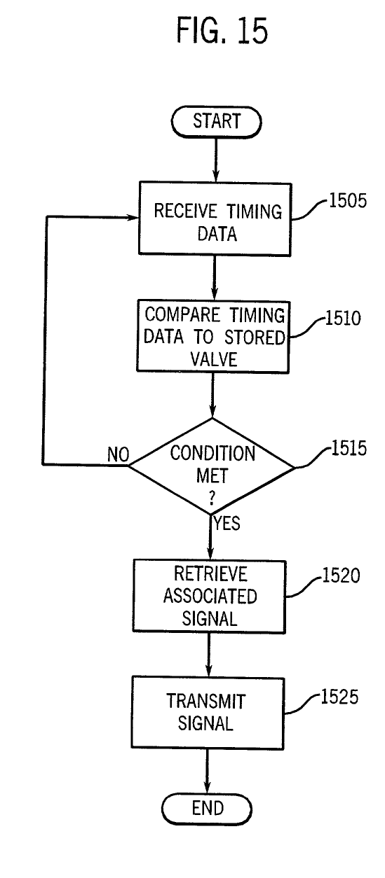

In operation, control circuit is configured receive programming instructions from an operator. According to an exemplary embodiment, the operator can utilize operator input device 1201 to initiate a programming mode. Initiation of a programming mode can be indicated on visual display 1210. Following programming, an event time can be recorded in memory 1204. The programming mode implementation and the content of the information displayed on visual display 1210 can take many exemplary embodiments depending on the functionality provided by control circuit 1202. Exemplary embodiments of possible functionality are described with reference to FIGS. 14 and 15.

Following programming, control circuit 1202 can continuously receive current timing information from timing circuit 1208. Control circuit 1202 can compare the received current timing information to the event time stored in memory 1204. If the values correspond, control circuit 1202 can signal transceiver circuit 1206 to transmit a control code to remote electronics system 1220.

Referring now to FIG. 13, an exemplary wireless control system 1300 is illustrated coupled to a vehicle interior element, namely an overhead console 1310. Overhead console 1310 can be of conventional construction, employing a plastic housing surrounded by an exterior cover. Wireless control system 1300 can be mounted to overhead console 1310 by conventional means, such as clips, screws, snaps, barbs, bosses, mounting grooves, etc.

Wireless control system 1300 can include a plastic faceplate 1320 having a visual display 1330, a logo 1340, and three push buttons 1350, 1351, and 1352 disposed therein. According to an exemplary embodiment, visual display 1330 can be a standard LED display for a digital clock, including an hours indicia, a minutes indicia, and/or a second indicia, each of which can be separated by a colon. According to an alternative embodiment, visual display 1330 can be an LCD display, a cathode ray tube, or any other type of visual display. Visual display 1330 can further include a day of the week indicator and/or a date indicator. The embodiment shown in FIG. 13 is merely exemplary, and alternative embodiments may take a variety of shapes and sizes and have a variety of different elements.

In operation, push buttons 1350, 1351, and 1352 can be used as an operator input device to program wireless control system 1300. According to an exemplary embodiment, push button 1350 can be held in a depressed position for a period of three seconds to initiate a programming mode. After three seconds, visual display 1330 can indicate that the programming mode has been initiated. The indication can be an LED indicator, a flashing display, a display indicator, or any other indicia.

Following initiation of programming, button 1350 can be depressed to set an event time hour, button 1351 can be depressed to set an event time minute and button 1352 can be depressed to set an event time second. Following entry of the event time, button 1350 can be again depressed and held to indicate that the desired event time has been set.

Following entry of an event time, buttons 1350, 1351 and 1352 can be used to select a control signal for association with the event time. The control signal can be selected using button 1351 to scroll through a list of control signals currently associated with buttons. For example, visual display 1320 can display a listing including “Button 1, Button 2, and Button 3”, wherein “Button 1” is highlighted. The operator can depress button 1351 to highlight the next sequential entry in the listing, etc. When the button associated with the desired control signal is highlighted, the user can depress button 1350 to make the association and complete the programming. According to an alternative embodiment, the control signal can be entered concurrently with programming using a control signal capture method. Thereafter, when a timing signal provided by timing circuit 1208 corresponds to the stored event time in memory 1204, the associated control signal can be transmitted.

One possible embodiment for programming wireless control system 1300 has been described for illustrative purposes. According to alternative embodiments, different configurations of components and different programming methods can be used to associate the transmittal of a control signal with a timing signal.

Referring now to FIG. 14, an exemplary method of training a wireless control system including a timing circuit for wireless control of a remote electronic system will now be described. At step 1405, control circuit 1202 identifies whether the user has requested system 1200 to enter a training mode to begin training. The request can be made wherein the user depresses a control switch 1351, 1352, or 1353 or any combination thereof for a predetermined time.

Once training has begun, at step 1410, control circuit 1202 receives an indication of the type of timing information to be utilized. According to an exemplary embodiment, the timing information can be a time of day or an elapsed time. The indication can be made be highlighting a specific option in visual display 1210 or based on which button 1350, 1351, or 1352 is depressed to enter the training mode.

If the timing information is selected to be an elapsed time, a countdown timer can be displayed on visual display 1210 in a step 1415. The timer can initially display a default countdown time. Visual display 1210 can include an hours indicator, a minute indicator and a second indicator. In a step 1420, the user can use buttons 1350, 1351, and 1352 to increase or decrease the indicators based on the desired elapsed time. Upon completing entry of a desired elapsed time, the operator can depress and hold a button or combination of buttons to indicate completion of elapsed time entry. In operation, the elapsed time can be based on the elapsed time from the occurrence of an event. The event can be depression of a button 1350, 1351 or 1352, or some external event such as ignition of the vehicle or when the vehicle is turned off. For example, the operator can program control circuit 1202 to close the garage door 10 minutes after the operator has turned off the vehicle.

If the timing information is selected to be an event time of day, an event time of day timer can be displayed on visual display 1210 in a step 1430. The timer can initially display a default event time. The timer display can include an hours indicator, a minute indicator and a second indicator. In a step 1435, the user can use buttons 1350, 1351, and 1352 to increase or decrease the indicators based on the desired event time. Upon completing entry of a desired event time, the operator can depress and hold a button or combination of buttons to indicate completion of event time entry. In operation, the event time can be the time at which the operator desires a control signal to be transmitted to a remote electronics system. For example, an operator may wish to program control circuit 1202 to close a garage door at 10 o'clock at night.

Following entry of the elapsed time or the event time, a step 1425 can be performed wherein the timing information is associated with a particular control signal for a remote electronics system 1220. The control signal can be a control signal that was previously associated with a button 1350, 1351 or 1352 or it can be a control signal entered and stored exclusively for use with the timing information. Following step 1425, the entered timing information and association can be stored in memory in a step 1450 and training can be completed in a step 1460.

Referring now to FIG. 15, a method of wireless control of a remote electronics system based on timing information will now be described, according to an exemplary embodiment. The method can be operable in hardware and/or software on system 1200 in any of its various embodiments.

At step 1505, a timing signal can be transmitted from timing circuit 1208 to control circuit 1202. The timing signal can be a time of day, an oscillation count, or any type of signal that can be utilized by control circuit 1202 to calculate an elapsed time or a time of day. In a step 1510, control circuit 1202 compares the timing signal to a timing value stored in memory 1204. The timing value stored in memory value 1204 can be a value entered and stored using a training method similar to that described with reference to FIG. 14.

Following step 1510, control circuit 1202 makes a determination in a step 1515 whether the timing signal received corresponds to the timing value stored in memory. If the timing signal does not correspond, the control circuit returns to step 1505 until a new timing signal is received. If the timing signal does correspond, a step 1520 is performed wherein a control signal associated with the timing value stored in memory is retrieved from memory. The control signal can then be transmitted in a step 1525 using transceiver 1206.

The features of the exemplary embodiments herein are particularly useful with garage door opener systems which can be programmed in a “down only” mode, wherein the garage door will close when a wireless control signal is received, but if the garage door is already closed, the garage door will not open, but will remain closed. A second mode is that in which receipt of a wireless control signal will cause a garage door opener to open if closed and close if open, and stop if in the process of closing or opening. Thus, transmitter 1200 can be configured to transmit a unique message which will place the garage door opener into the first mode, without requiring the user to manually switch the mode of the garage door opener from the second mode to the first mode.

Utilizing the feature of a “down only” mode, in an alternative embodiment of transmitter 1200, transmitter 1200 is configured to transmit a wireless control signal having control data which will control a garage door opener to close if the garage door is open and to remain closed if the garage door is already closed when the wireless control signal is received.

In some situations, a garage door opener will not be configurable for “close only” operation. In these situations, an auxiliary wireless transmitter can be used. The auxiliary wireless transmitter is disposed in the vicinity of the garage door opener (e.g., coupled to the garage wall, ceiling, or a mounting bracket) and includes a housing, a receiver, a control circuit, a garage door state sensor, and an interface circuit. The garage door state sensor is configured to detect whether the garage door is open or closed. For example, a mercury switch is coupled to the garage door which changes state based on whether the switch (or door) is horizontal (garage door open) or vertical (garage door closed). The switch includes an interface circuit configured to transmit the switch state over a wired or wireless connection to the auxiliary wireless transmitter. The auxiliary wireless transmitter is configured to receive the switch state and wireless control data from transmitter 1200 indicating a “close only” command. If the garage door is open, the auxiliary wireless transmitter will send a “close door” command via an interface circuit having a wired or wireless communication link to the garage door opener to close the garage door. The receiver, control circuit, and interface circuit are all coupled to and preferably at least partially recessed in the housing. The interface circuit is configured to provide the “close door” command from within the housing to the existing garage door opener outside the housing. If the garage door is already closed, the auxiliary wireless transmitter will not send a command to the garage door opener. In this embodiment, the auxiliary wireless transmitter and garage door state sensor act as a kit which provides “close-only” functionality to an existing garage door opener.

While the exemplary embodiments illustrated in the FIGS. and described above are presently preferred, it should be understood that these embodiments are offered by way of example only. For example, alternative embodiments may be suitable for use in the commercial market, wherein office lights or security systems or parking garage doors are controlled. Further, navigation data can take many forms other than GPS data, compass data, and distance traveled data. Accordingly, the present invention is not limited to a particular embodiment, but extends to various modifications that nevertheless fall within the scope of the appended claims.

What is claimed is:

1. A wireless control system for wireless control of a remote electronic system, comprising:
a wireless control system circuit, comprising:
a transmitter circuit configured to transmit a wireless control signal having control data which will control the remote electronic system;
a timing circuit configured to transmit a timing signal; and
a control circuit coupled to the transmitter circuit and the timing circuit configured to receive the timing signal and to command the transmitter circuit to transmit the wireless control signal based on the timing signal.

2. The wireless control system of claim 1, wherein at least the transmitter circuit and the control circuit are coupled to a vehicle interior element.

3. The wireless control system of claim 1, wherein the remote electronic system is a home electronic system.

4. The wireless control system of claim 1, wherein at least the wireless control circuit is disposed within a keyfob.

5. The wireless control system of claim 1, wherein the remote electronic system is a garage door opener and the control data is configured to control the garage door opener.

6. The wireless control system of claim 1, further comprising a receiver circuit configured to receive a wireless signal, wherein the control circuit is configured to identify and store a data code on the wireless signal, wherein the wireless control signal transmitted by the transmitter circuit includes the stored data code.

7. The wireless control system of claim 1, wherein the timing circuit includes a receiver configured to receive a second timing signal.

8. The wireless control system of claim 7, wherein the receiver is a radio wave receiver.

9. The wireless control system of claim 1, wherein the timing circuit is a clock mounted in a vehicle interior.

10. The wireless control system of claim 1, wherein the timing circuit is a crystal chip timing mechanism.

11. A method of training a wireless control system for wireless control of a remote electronic system based on a timing signal, comprising:
receiving a request to begin training from a user;
receiving a timing target;
recording the timing target;
associating a wireless control signal with the timing signal; and
receiving a request to end training from the user.

12. The method of claim 11, wherein the request to begin training is received via a pushbutton coupled to the interior of the vehicle.

13. The method of claim 11, wherein the receiving a timing target includes presenting selectable timing options on a visual display.

14. The method of claim 13, wherein the receiving a timing signal includes receiving a selection of one of the selectable timing options.

15. The method of claim 11, wherein the timing target is a time of day.

16. The method of claim 11, further comprising receiving an indication from the user as to which of a plurality of wireless control signals is to be transmitted based on the timing target.

17. The method of claim 11, further comprising:
receiving a wireless signal having a data code; and
identifying and storing the data code on the wireless signal, whereby the wireless control system can wirelessly control the remote electronic system by transmitting the data code of the wireless signal.

18. A method of wirelessly controlling a remote electronic system based upon a timing signal using a wireless control system, comprising:
receiving a timing signal from a timing circuit;
retrieving a stored timing value;
comparing the timing signal to the stored timing value; and
transmitting a wireless control signal having control data which will control the remote electronic system when the timing signal corresponds to the stored timing value.

19. The method of claim 18, wherein the control data is configured to control a garage door opener.

20. The method of claim 18, wherein the step of transmitting includes transmitting a plurality of wireless control signals having different control data which will control a plurality of remote electronic systems when the timing signal corresponds to the stored timing value.

21. The method of claim 18, wherein the timing circuit is a clock disposed within a vehicle interior.

22. The method of claim 18, wherein the timing signal includes a time of day.

23. The method of claim 18, wherein the timing signal includes an elapsed time.

24. The method of claim 23, wherein the elapsed time is initiated upon occurrence of an event.

25. The method of claim 24, wherein the event is vehicle ignition.

26. A transmitter for wirelessly controlling a plurality of remote electronic systems, comprising:
a wireless circuit, comprising:
a memory configured to store a plurality of control data messages, each control data message configured to control a different remote electronic system;
a transmitter circuit configured to transmit the control data messages to the different remote electronic systems;
a timing circuit configured to provide a timing signal; and
a control circuit configured to command the transmitter circuit to transmit a wireless control signal containing one of the control data messages in response to the timing signal provided by the timing circuit.

27. The transmitter of claim 26, wherein the wireless circuit is coupled to a vehicle interior element.

28. The transmitter of claim 26, wherein the remote electronic system is a home electronic system.

29. The transmitter of claim 26, wherein the wireless circuit is disposed within a keyfob.

30. The transmitter of claim 26, wherein the control circuit commands the transmitter circuit to transmit one of the control data messages based on a determination that the timing signal indicates a time of day equivalent to a predetermined time of day.

31. The transmitter of claim 26, further comprising an operator-actuatable switch coupled to the control circuit, wherein the control circuit is user-programmable such that the switch causes the transmitter to send a first wireless control signal having a first control data message and the control circuit automatically sends a second wireless control signal having a second control data message different than the first control data message, wherein the first and second wireless control signals are sent following expiration of a time period.

32. The transmitter of claim 26, wherein the transmitter circuit is mounted within an overhead console, a visor, or an instrument panel.

33. The transmitter of claim 26, wherein the control circuit is configured to be programmed by the user as to which of the wireless control signals are to be transmitted in response to the timing signal.

34. The transmitter of claim 26, further including a visual display coupled to the control circuit and configured to display information provided by the control circuit. The transmitter of claim 29, further comprising an operator-actuatable switch coupled to the control circuit, wherein depression of the switch initiates a programming phase wherein a wireless control signal is set to be transmitted based on the timing signal from the timing circuit.

35. A wireless control system, the wireless control system comprising:
a computer coupled to a vehicle interior element;
a transmitter in communication with the computer, the transmitter being configured to transmit a wireless control signal having control data which will control a remote electronic system;
a timer in communication with the computer, the timer being configured to provide a timing signal; and
a control program operative on the computer, the computer being programmed by the control program to receive data from the timing signal and to send a command signal to the transmitter to transmit the wireless control signal based on the data from the timing signal.

36. The wireless control system of claim 35, wherein the remote electronic system is a garage door opener and the control data is configured to control the garage door opener.

37. The wireless control system of claim 35, wherein the remote electronic system is a home electronic system.

38. The wireless control system of claim 35, further comprising an operator input device coupled to the computer, wherein the control circuit is further configured to command the transmitter circuit to transmit the wireless control signal in response to actuation of the operator input device.

39. The wireless control system of claim 35, further comprising an operator input device coupled to the computer, wherein the control circuit is further configured to command the transmitter circuit to transmit the wireless control signal in response to actuation of the operator input device.
